(19) United States
(12) Patent Application Publication
(10) Pub. No.: US 2020/0285630 A1
(43) Pub. Date: Sep. 10, 2020

(54) SYSTEMS AND METHODS FOR APPLICATION DATA TRANSACTION AUDITING

(71) Applicant: JPMorgan Chase Bank, N.A., New York, NY (US)

(72) Inventor: Dilip Seshadri, Bangalore (IN)

(21) Appl. No.: 16/292,486

(22) Filed: Mar. 5, 2019

(51) Int. Cl. G06F 16/23; G06F 16/22

(52) U.S. Cl. CPC G06F 16/2379; G06F 16/2365; G06F 16/2282

(57) ABSTRACT

Systems and methods for application data transaction auditing are disclosed. In one embodiment, in an information processing apparatus comprising at least one computer processor, a method for application data transaction auditing may include: (1) receiving an audit enablement request for transaction data, the audit enablement request comprising an identification of a plurality of transaction tables and a request to generate a script for at least one of an audit trigger, an audit table DDL, and an audit sequence for each transaction table; (2) for each transaction table: (a) retrieving information for the transaction table; (b) generating the script for the at least one of the audit trigger, the audit table DDL, and the audit sequence; and (c) updating the audit configuration table with the generated script.

### BACKGROUND OF THE INVENTION

### 1. Field of the Invention

The present disclosure generally relates to systems and methods for application data transaction auditing.

### 2. Description of the Related Art

Transactional auditing is often performed at the database level. This leads to a lack of consistency in the way that auditing is performed. In addition, because the same code is often reused, resources are often wasted.

### SUMMARY OF THE INVENTION

Systems and methods for application data transaction auditing are disclosed. In one embodiment, in an information processing apparatus comprising at least one computer processor, a method for application data transaction auditing may include: (1) receiving an audit enablement request for transaction data, the audit enablement request comprising an identification of a plurality of transaction tables and a request to generate a script for at least one of an audit trigger, an audit table DDL, and an audit sequence for each transaction table; (2) for each transaction table: (a) retrieving information for the transaction table; (b) generating the script for the at least one of the audit trigger, the audit table DDL, and the audit sequence; and (c) updating the audit configuration table with the generated script.

In one embodiment, the request to generate the script may include a flag.

In one embodiment, the information for the transaction table may include metadata.

In one embodiment, the metadata may include at least one of a number of columns, a column length, and a datatype.

In one embodiment, the audit trigger script may capture a transaction event and metadata in the transaction table and updates an audit table with the transaction event and metadata.

In one embodiment, the transaction event may be one of an entry addition, an entry deletion, and an entry modification in the transaction table.

In one embodiment, the metadata may include an author of the transaction event and a date and time of the transaction event.

In one embodiment, the audit table DDL script may define the audit schema for the transaction table.

In one embodiment, the audit sequence script may generate a unique value for each new entry in an audit table.

According to another embodiment, in an information processing apparatus comprising at least one computer processor, a method for auditing transaction data in a transaction table may include: (1) a trigger script identifying a transaction event in a transaction table; (2) the trigger script collecting metadata for the transaction event; and (3) the trigger script updating an audit table for the transaction table with the transaction event and the metadata.

In one embodiment, the transaction event may be one of an entry addition, an entry deletion, and an entry modification in the transaction table.

In one embodiment, the metadata may include an author of the transaction event and a date and time of the transaction event.

In one embodiment, the trigger script may identify the transaction event in a second transaction table.

In one embodiment, the second transaction table may be identified in an audit configuration table.

In one embodiment, the audit table may have a standardized format.

According to another embodiment, in an information processing apparatus comprising at least one computer processor, a method for performing an audit validation process may include: (1) retrieving an audit table definition for a transaction table in an audit table; (2) identifying an inconsistency between the audit table definition and the transaction table; (3) capturing the inconsistency; and (4) generating script to update the audit table.

In one embodiment, the inconsistency may include an addition of a column in the transaction table, a removal of a column in the transaction table, and a change in a data type in a column in the transaction table.

In one embodiment, the script may be an alter script.

In one embodiment, the audit table definition may be in an audit configuration file.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for application data transaction auditing according to one embodiment;

FIG. 2 depicts a method for application data transaction auditing according to one embodiment;

FIG. 3 depicts an audit process method according to another embodiment;

FIG. 4 depicts an audit validation process according to another embodiment.

### DETAILED DESCRIPTION OF PREFERRED EMBODIMENTS

Embodiments disclosed herein relate to systems and methods for application data transaction auditing.

Embodiments are directed to a standardized software change audit process in which may be plugged-in seamlessly with the capture of information that is relevant to any data change. In embodiments, the audit framework may provide some or all of the following: (1) automate the generation/creation of audit tables/sequences using metadata based investigation/analysis of the transaction table; (2) automate the generation/creation of triggers to capture insert/update/delete on the transaction tables along with a unique transaction id and the business user details; and (3) match the previous transaction id by uniquely identifying the previous transaction on the audit table for a unique record by, for example, using required field details in an audit configuration table to uniquely identify a record within a transaction table.

In embodiments, a formula-based spreadsheet may enable the insertion into the audit configuration table for automated generation of audit data definition language (DDL) for any new transaction table that may be audited. In addition, a software component may be provided to facilitate maintenance of the audit table/audit trigger definitions in relation to changes in the transaction table definition. For example, the software component may validate the correctness and the relevance of the audit tables in relation to the transaction tables. This software component may help application teams with the maintenance of the audit schema as required based on any disparities with the transaction schema.

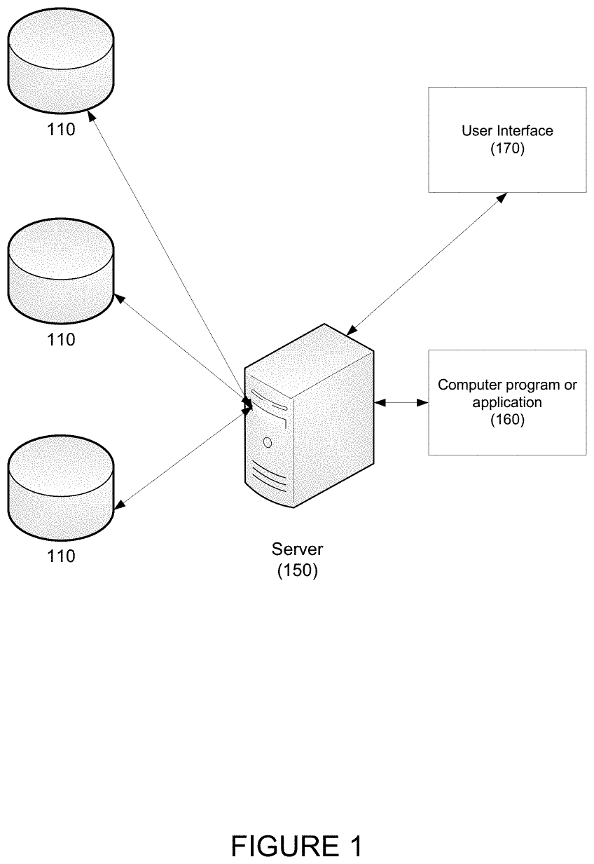

Referring to FIG. 1, a system for application data transaction auditing is disclosed according to one embodiment. System 100 may include data source(s) 110, server 150, computer program or application 160 executed by server 150, and user interface 170. In one embodiment, data source 110 may be a source of transaction data. As indicated in FIG. 1, more than one data source 110 may be provided. For example, each data source 110 may be associated with a specific environment, such as a development environment, production environment, quality assurance environment, etc.

In one embodiment, the audit of transaction data may be included as part of the transaction execution environment across all data source(s) 110.

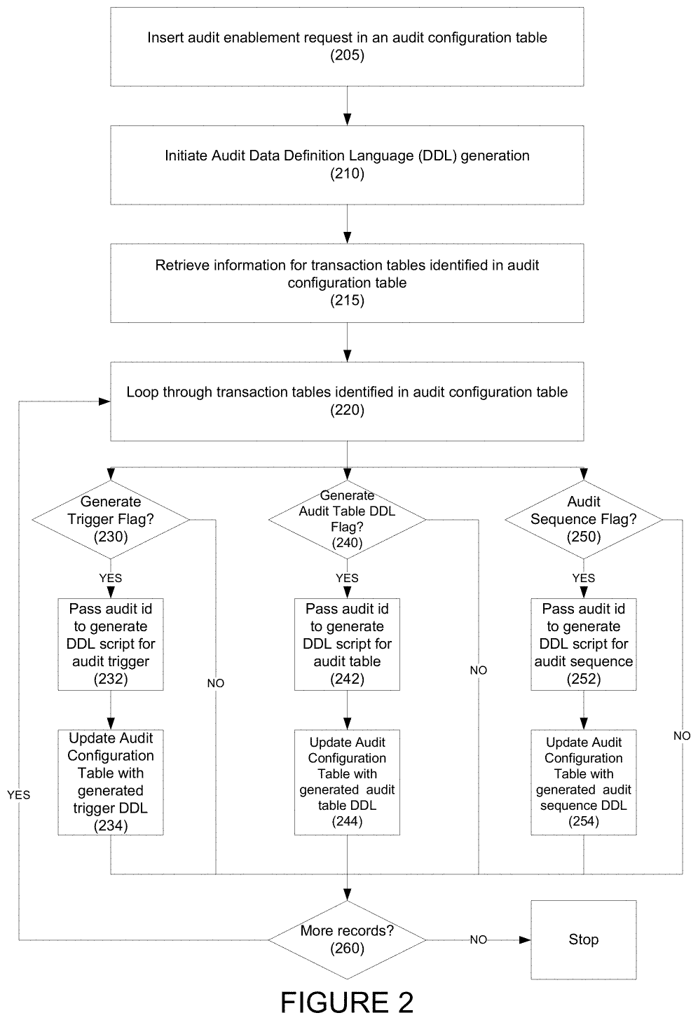

FIG. 2 depicts a method for application data transaction auditing according to one embodiment. In step 205, an audit enablement request may be inserted into an audit configuration table. The audit enablement request may be inserted by an application development team for plugging-in/authoring the transaction audit for one or more application transaction tables.

In one embodiment, the audit enablement request may include an identification of the transaction table(s) for which the auditing is to be generated/plugged-in. It may further include indicators, such as flags, that indicate whether triggers, audit table DDLs, audit sequences, etc. should be generated for each transaction table.

In step 210, an audit DDL script process may be initiated based on the audit enablement request.

In step 215, the information for the transaction tables identified in the audit configuration table may be retrieved. For example, the metadata for the identified transaction tables (e.g., columns, datatypes, column lengths, etc.) may be retrieved.

In step 220, the process may loop through the records in the audit configuration file to check for completeness. For example, the any transaction table that was identified in the audit configuration table may be reviewed, and the audit schema DDL will be generated.

If, in step 230, a trigger flag is identified, in step 232, the audit id may be passed to generate a DDL script for the audit trigger, and in step 234, the audit configuration file may be updated with the trigger DDL script. For example, if a generate trigger flag for one of the configuration entries in the audit configuration table is set to yes or similar, the program will generate the audit trigger that contains the intelligence to capture the transaction detail from the transaction table and update the audit table.

In one embodiment, the audit trigger is responsible for capturing any transaction event (e.g., insert, update, delete, etc.) on the transaction table and recording the same into its corresponding audit table. It may further capture metadata for the transaction event, such as author, date and time of event, etc.

If, in step 240, if an audit table DDL flag is identified, in step 242, the audit id may be passed to generate a DDL script for the audit table, and in step 244, the audit configuration file may be updated with the audit table DDL script. For example, the audit table DDL script may represent the audit table definition language and may be used to define the audit schema for the corresponding transaction table.

If, in step 250, if an audit sequence flag is identified, in step 252, the audit id may be passed to generate a DDL script for the audit sequence, and in step 245, the audit configuration file may be updated with the audit sequence DDL script. For example, the audit sequence DDL script may represent the audit sequence definition language, and may be used to generate a unique value for every new audit entry into the audit table.

If, in step 260, there are more records, the process may loop back to step 220. If there are no further records, the process may be complete.

Once all records are reviewed, the generation of the audit definition language based on the configurations in the audit configuration table is complete.

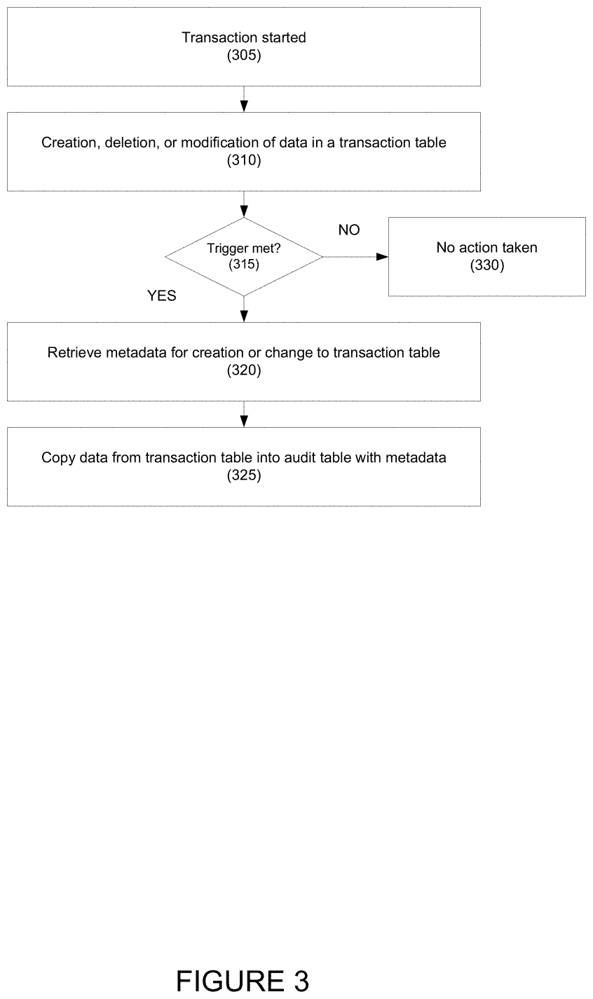

FIG. 3 depicts an audit process according to one embodiment. In step 305, a transaction may be started, and in step 310, an entry, deletion, or modification may be made to a transaction table. Any suitable type of transaction table may be used. Examples of transaction tables include employee tables, company tables, project tables, approval tables, provisioning tables, etc.

In one embodiment, the change may be in a specific transaction table, or in another transaction table. For example, the audit configuration table may include audit enablement requests for the generation of audit schema for a specific transaction table. Once the audit schema generation process is complete, the generated scripts may be executed to tie the audit trigger on the transaction table that contains the logic to audit the transactions from the transaction table corresponding to the audit table.

In step 315, a trigger script from an audit configuration table may be compared to the entry, deletion, or modification. If the trigger condition is met, in step 320, metadata for the entry, deletion, or modification may be collection.

In one embodiment, the metadata for the transaction table may be retrieved from the table definition using, for example, system tables. For example, system tables in the system running the audit generation process (e.g., Oracle) may be used.

In one embodiment, any entry, deletion, or modification may automatically trigger the collection of the metadata.

In step 325, data from the transaction table, or from the other transaction table, including the entry, deletion, or modification and the metadata, may be copied to an audit table.

If, in step 315, the trigger script is not met, no action is taken.

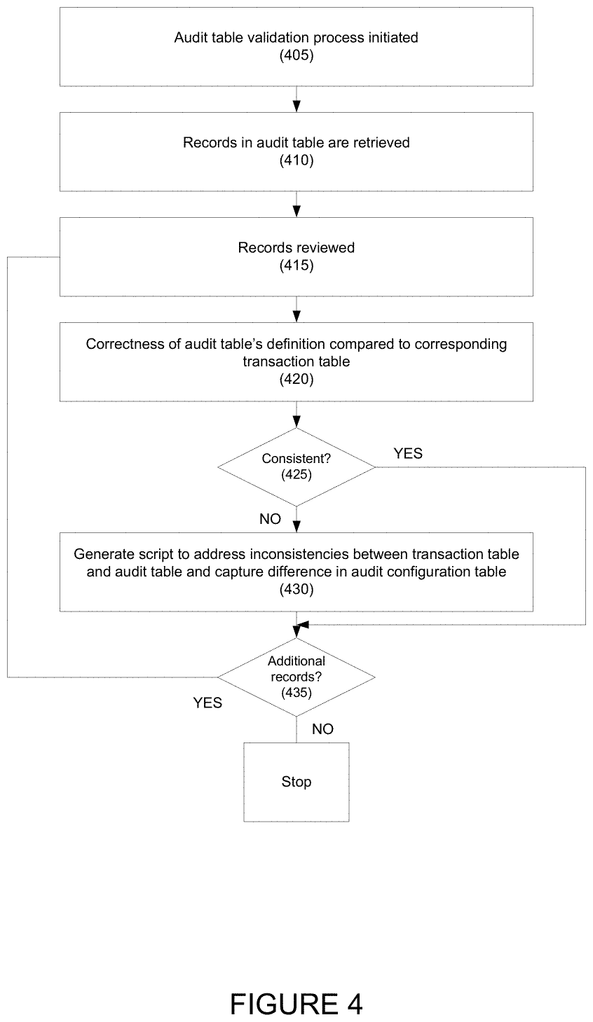

FIG. 4 depicts an audit validation process according to one embodiment. In one embodiment, the audit framework may include a validation process that enables the maintenance of audit tables and/or triggers.

For example, a transaction table may evolve as new information/data points are captured. Thus, the audit table may need to be updated so that all transaction information is captured.

In step 405, the audit table validation process may be initiated, and in step 410, records (e.g., identified transaction tables, flags, etc.) in the audit table may be retrieved.

In one embodiment, the audit table validation process may be initiate periodically, on demand, or as otherwise necessary and/or desired.

In step 415, the records in the audit configuration table may be reviewed. In one embodiment, the records may be reviewed in series, such as in a loop.

In step 420, the correctness of the audit table's definition with the corresponding transaction table definition may be verified. For example, a validate subroutine may compare the definition of the transaction table and the audit table to identify inconsistencies. Examples of inconsistencies include the addition of new columns in the transaction table that are not present in the audit table, removal of column(s) from the transaction table, any changes to the data type of any column in the transaction table that has not been included in the audit table, etc.

In step 425, if the audit table configuration's definition is not consistent with the transaction table, in step 430, a script is generated to address the inconsistencies between the transaction table and audit table, and to capture the difference in the corresponding column in the audit configuration table. In one embodiment, an alter script may be used for this purpose.

In one embodiment, based on the inconsistency or inconsistencies, the DDL for audit table/trigger may be regenerated.

If the audit table definition is consistent, in step 435, a check is made if there are more records. If more records exist, the records are reviewed in step 415. If there are no additional records, the process may be completed in step 440.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for auditing transaction data, comprising:
in an information processing apparatus comprising at least one computer processor:
receiving an audit enablement request for transaction data, the audit enablement request comprising an identification of a plurality of transaction tables and a request to generate a script for at least one of an audit trigger, an audit table DDL, and an audit sequence for each transaction table;
for each transaction table:
retrieving information for the transaction table;
generating the script for the at least one of the audit trigger, the audit table DDL, and the audit sequence; and
updating the audit configuration table with the generated script.

2. The method of claim 1, wherein the request to generate the script comprises a flag.

3. The method of claim 1, wherein the information for the transaction table comprises metadata.

4. The method of claim 3, wherein the metadata comprises at least one of a number of columns, a column length, and a datatype.

5. The method of claim 1, wherein the audit trigger script captures a transaction event and metadata in the transaction table and updates an audit table with the transaction event and metadata.

6. The method of claim 5, wherein the transaction event is one of an entry addition, an entry deletion, and an entry modification in the transaction table.

7. The method of claim 5, wherein the metadata comprises an author of the transaction event and a date and time of the transaction event.

8. The method of claim 1, wherein the audit table DDL script defines the audit schema for the transaction table.

9. The method of claim 1, wherein the audit sequence script generates a unique value for each new entry in an audit table.

10. A method for auditing transaction data in a transaction table, comprising:
in an information processing apparatus comprising at least one computer processor:
a trigger script identifying a transaction event in a transaction table;
the trigger script collecting metadata for the transaction event; and
the trigger script updating an audit table for the transaction table with the transaction event and the metadata.

11. The method of claim 10, wherein the transaction event is one of an entry addition, an entry deletion, and an entry modification in the transaction table.

12. The method of claim 10, wherein the metadata comprises an author of the transaction event and a date and time of the transaction event.

13. The method of claim 10, wherein the trigger script identifies the transaction event in a second transaction table.

14. The method of claim 13, wherein the second transaction table is identified in an audit configuration table.

15. The method of claim 10, wherein the audit table has a standardized format.

16. A method for performing an audit validation process, comprising:
in an information processing apparatus comprising at least one computer processor:
retrieving an audit table definition for a transaction table in an audit table;
identifying an inconsistency between the audit table definition and the transaction table;
capturing the inconsistency; and
generating script to update the audit table.

17. The method of claim 16, wherein the inconsistency comprises an addition of a column in the transaction table, a removal of a column in the transaction table, and a change in a data type in a column in the transaction table.

18. The method of claim 16, wherein the script is an alter script.

19. The method of claim 16, wherein the audit table definition is in an audit configuration file.
